(19) United States
(12) Patent Application Publication
(10) Pub. No.: US 2026/0212364 A1
(43) Pub. Date: Jul. 23, 2026

(54) SYSTEMS AND METHODS FOR MACHINE LEARNING BASED FRAUD DETECTION IN CHECKS FOR POSITIVE PAY APPLICATIONS

(71) Applicant: Q2 Software, Inc., Austin, TX (US)

(72) Inventors: Barbara de Graaf, Toronto (CA); Pooja Ravi, Toronto (CA); Angelica Y. Gascon, Austin, TX (US); Daniel Wagner, Thornhill (CA); Frederico Tommasi Caroli, Burnaby (CA); Kollol Das, Toronto (CA)

(21) Appl. No.: 19/421,784

(22) Filed: Dec. 16, 2025

Related U.S. Application Data
(60) Provisional application No. 63/734,548, filed on Dec. 16, 2024.

(51) Int. Cl. G06Q 20/40

(52) U.S. Cl. CPC G06Q 20/4016

(57) ABSTRACT

Systems and methods for machine learning based fraud detection in checks for positive pay applications are provided. Various embodiments of the present technology provide systems and methods for overcoming deficiencies in prior systems, particularly the lack of explainability and high false positive rates. Embodiments extract payee information using a trained model and compares it with issued data. This process generates discrete, explainable matching signals for identified mismatches. A decision learning feature stores human review decisions based on key check identifiers, automatically filtering fraud signals for recurring legitimate transactions. Additionally, image feature clustering techniques are employed to curate robust datasets representative of real-world production data for model training.

### CROSS-REFERENCE TO RELATED APPLICATION(S)

This application claims the benefit of priority under 35 U.S.C. § 119(e) from U.S. Provisional Patent Application No. 63/734,548, filed on Dec. 16, 2024, entitled “SYSTEMS AND METHODS FOR MACHINE LEARNING BASED FRAUD DETECTION IN CHECKS FOR POSITIVE PAY APPLICATIONS,” which is incorporated by reference herein in its entirety for all purposes.

### TECHNICAL FIELD

This disclosure relates generally to computer security. In particular, embodiments of this disclosure relate to computer based anomaly detection. Even more particularly, embodiments of this disclosure relate to machine learning based anomaly detection using computer vision, structured data extraction or natural language processing. Specifically, embodiments of this disclosure relate to the use and implementation fraud detection in positive pay for checks, based on machine learning based anomaly detection using advanced algorithms.

### BACKGROUND

Processes have arisen in many areas that require a human with some form of knowledge or involvement in a particular field to perform visual analysis on an image (or series of images or a video) in order to determine or solve a problem. These problems, for the most part, relate to detection of a particular feature in an electronic image. In many cases, this feature indicates an anomaly (e.g., problem) of some type. Accordingly, this type of image analysis may be related, for example, to security, quality control in product manufacturing, analysis of medical imaging, plant or wildlife identification, etc. A microcosm of these issues occurs with respect to computer security in the context of check deposits, payment or processing. The vast majority of check deposits and processing is now done electronically. Fraud is rampant in this context.

Institutions involved in such check processing (e.g., financial institutions) may thus face significant challenges in preventing check payment fraud for business customers as fraudsters adopt more sophisticated fraud techniques, making it difficult to detect altered, forged or fake checks. Variations in how payee names are recorded, errors in data extraction from handwritten or complex layouts, and reliance on manual verification create inefficiencies. As a result, fraudulent checks can bypass scrutiny, leading to financial losses. If a check is fraudulent and a business fails to report it promptly, the financial loss typically falls on the business customer, not the financial institution, under the Uniform Commercial Code (UCC) guidelines.

Certain computer security systems implementing check fraud solutions may utilize automated image analysis and fraud scoring to detect check fraud. These computer security systems have, however, proved inadequate to address detection of check fraud in real world contexts. As but one important deficiency, these systems lack lacks explainability in their fraud detection and their fraud scoring system, making it difficult for financial institutions reviewing the outputs of such computer security systems difficult, as it may hard to understand or justify flagged transactions in order to make an informed decision to pay or decline check based on the output of the computer security system. Additionally, these previous solutions do not incorporate certain data from (evaluation of) past checks (e.g., decision learning from past checks), limiting their ability to adapt and improve fraud detection over time. Accordingly, there is a need for improved computer security systems and, in particular, improved computer security systems for use in detecting check fraud.

More specifically, there are certain contexts of check fraud detection which are particularly poorly served by current computer systems. This context involves the matching of payee fields between different checks (for example, from checks presented for payment and checks as originally issued from a financial institution or other entity). This context is referred to as “positive pay” or “positive pay match”. Positive pay is usually a service provided by financial institutions to their customers. Entities (e.g., a business) may share the list of checks that it issues on a daily-basis, so all the information can be confirmed when someone cashes a check in the list. This protects the entity against forged, altered and counterfeit checks. Any suspicious checks the automated system identifies may be sent to the entity for verification.

Positive pay solutions for checks are designed to combat fraud by ensuring that checks presented for payment match the details provided in the original check-issue file, specifically the payee information. There are a number of issued with computer security systems implementing positive pay solutions. As one problem, extracting and accurately matching payee data from these checks presents numerous challenges, some of which are particular to checks and some of which are specific to the payee field itself. Checks are documents with specific formats and layouts, which makes it difficult to find a suitable solution, such as a large language model (LLM), that can reliably extract and parse relevant data. This task is further complicated when dealing with handwritten checks, where variability in handwriting and formatting can introduce errors in extraction. Additionally, checks often feature complex elements such as watermarks, logos, and specific words or phrases like “Attn” or “Inc.” that need to be ignored during processing. Another challenge arises with business checks, as many payments are recurring, requiring the system to learn and adapt from past decisions to improve future accuracy. Lastly, positive pay solutions must be capable of processing a high volume of checks efficiently, maintaining scalability while ensuring accurate results across a wide range of check types and conditions.

### SUMMARY

Systems/methods are described that detect anomalies in checks using a positive pay match system by receiving a check image and associated issued check data, including an issued payee name. The process involves performing check preprocessing, which includes image normalization and optical character recognition (OCR), where the OCR is configured to recognize handwritten text and produce OCR output. A trained multi-modal transformer model extracts a set of fields from the OCR output, including an extracted payee name. The extracted payee name is then compared against the issued payee name using a payee matching algorithm. This algorithm includes tokenizing the issued and extracted payee names, normalizing these tokens, and aligning them using a matching algorithm. Next, a list of matching signals is generated based on unaligned tokens, where each matching signal is a discrete unit of information describing a specific finding or mismatch. Finally, signal postprocessing is performed, which includes decision learning-based filtering configured to utilize human review feedback stored in a database to determine if the check associated with the check image should be flagged for human review.

In some embodiments, a computer security system for machine learning based fraud detection in checks for positive pay applications is described, comprising one or more processors coupled to a non-transitory computer readable medium storing executable instructions. The system implements a check preprocessing module configured to receive a check image and perform image normalization and optical character recognition (OCR), where the OCR is configured to recognize handwritten text and produce OCR output. A payee extraction module, comprising a trained multi-modal transformer model, is configured to extract a set of fields from the OCR output, including an extracted payee name. A payee matching module is configured to compare the extracted payee name against an issued payee name in the associated issued check data. This comparison involves tokenizing and normalizing the payee name tokens, and aligning the normalized tokens using a matching algorithm. The payee matching module is further configured to generate a list of matching signals based on unaligned tokens, where each matching signal is a discrete unit of information describing a specific finding or mismatch. Furthermore, a signal postprocessing module is configured to apply decision learning-based filtering to the matching signals, which utilizes human review feedback stored in a database to determine if the check should be flagged for human review.

In some embodiments, a computer program product is described, comprising a non-transitory computer readable medium storing instructions that, when translated by a processor, perform operations for detecting anomalies in checks. These operations include receiving a check image and associated issued check data, which contains an issued payee name, and performing check preprocessing, including image normalization and optical character recognition (OCR) configured to recognize handwritten text and produce OCR output. The instructions further extract a set of fields, including an extracted payee name, from the OCR output using a trained multi-modal transformer model. A payee matching algorithm is used to compare the extracted payee name against the issued payee name. This comparison involves tokenizing and normalizing the respective payee name tokens, and aligning the tokens using a matching algorithm. A list of matching signals is generated based on unaligned tokens, with each signal being a discrete unit of information describing a specific finding or mismatch. The translated instructions then perform signal postprocessing, including decision learning-based filtering configured to utilize human review feedback stored in a database to determine if a check associated with the check image should be flagged for human review.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts one embodiment of an architecture for a positive pay match system.

FIGS. 2A and 2B depict examples of check images presented for payment.

FIG. 3 illustrates how an IOB tagging scheme may be employed for token classification.

FIG. 4 depicts the clusters formed in a two-dimensional plane for visual understanding of the check image feature clustering process.

FIG. 5 is a block diagram representing an embodiment of a method for image clustering used for dataset expansion.

FIG. 6 is a flow chart illustrating one embodiment of a method for detecting anomalies in checks using a positive pay match system.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

As outlined above, processes related to computer security in the context of check deposits, payment or processing face significant challenges due to the fact that fraud is rampant. Financial institutions thus face challenges in preventing check payment fraud for business customers as fraudsters adopt more sophisticated techniques. A major deficiency of prior computer security systems implementing check fraud solutions is their lack of explainability in their detection and fraud scoring systems, offering only a subjective confidence score (e.g., 800) without clear justification. This black-box approach is problematic, especially when similar checks are flagged inconsistently, leaving clients without the context needed to trust the system or justify their decisions. Furthermore, conventional solutions often result in a high false positive rate (e.g., roughly 10-12%), where flagging too many checks as suspicious overwhelms business customer reviewers and dilutes their attention, making it more likely that genuine fraud will be missed. Prior solutions are also very cumbersome to set up, requiring extensive manual setup, and generally so not incorporate data from past checks (e.g., decision learning—described in detail below). Accordingly, there is a recognized need for an improved computer security system adapted for positive pay match that can overcome these technical problems—including those related to OCR errors, handwritten text extraction, and handling noisy images—by providing explainable signals and the technological capability to reduce the flagging rate.

Accordingly, embodiments herein may provide computer security systems adapted for positive pay match. Certain embodiments may include a check payee match pipeline with explainable fraud detection results, including providing signals that resulted in a check being flagged. Explainability may be crucial for users, as they need to understand why a check was flagged to make informed decisions about whether to pay or decline it.

In particular, embodiments may be adapted to achieve the goal of generating explainable signals, meaning that, given the system's output, a human reviewer of the data presented by embodiments of the positive pay match system as presented herein can easily be interpreted to explain why a check was flagged or otherwise determined for presentation for a user or of data presented in association with that check. These capabilities thus differ from previous solutions that output a confidence score without much further explanation on how that score was determined. As noted, this lack of transparency is problematic, especially when similar-looking checks are flagged inconsistently, leaving users without the context needed to trust the system or justify their decisions.

Embodiments may also include decision learning for positive pay. This decision learning may run for every check (or a subset of checks). Recurrent checks, like paycheck checks, may be reviewed at most once, since results of a previously adjudicated check can be stored (or user data associated with those previously adjudicated check) and skip verification on identical future checks (e.g., with the same or similar payee data). Embodiments can thus reduce false positives by learning from past decisions made by the business reviewer. If a flagged check was previously reviewed and approved, the system identifies recurring checks with the same key details and avoids flagging them again. This ensures that legitimate recurring checks are automatically cleared, overriding unnecessary fraud signals and streamlining the review process.

Embodiments may also determine a robust dataset for model training. It particular, it is essential to select a robust set that was representative of production or live data, and that yields extremely high accuracy to allow for a low flagging rate of checks being processed by a model. Embodiments may thus utilize a structured approach to dataset determination that allow the selection of a number of checks to produce a high quality model. For example, embodiments may utilize check image feature clustering for dataset consolidation. In some embodiments, to maintain the high accuracy necessary for a low flagging rate, the system utilizes a separate machine learning algorithm dedicated exclusively to data set expansion. This specialized algorithm is beneficial because the system processes a high volume of checks (e.g., 400,000 checks per day), and manually curating a representative test set would be inefficient. This separate algorithm ensures that the test set remains representative of the real-world production data distribution, enabling the main multi-modal transformer model to generalize well on unseen check samples.

Moreover, embodiments may utilize advanced techniques that allow these embodiments to be compatible with Model Risk Management (MRM), which is the framework suggested by the Federal Reserve (the FED) to manage machine learning models for banking. In some embodiments, the MRM process is structured around three stages. These stages include model development, which requires a clear statement of purpose and sound design, theory, and logic. The second stage is to build your test set, which necessitates a hand labeled source of truth and validation that the test set behaves as production data. The final stage is test and monitor, which requires testing with the test set on every release and monitoring production behavior. The system is designed, in some embodiments, to adhere to this framework to ensure model quality and regulatory compliance.

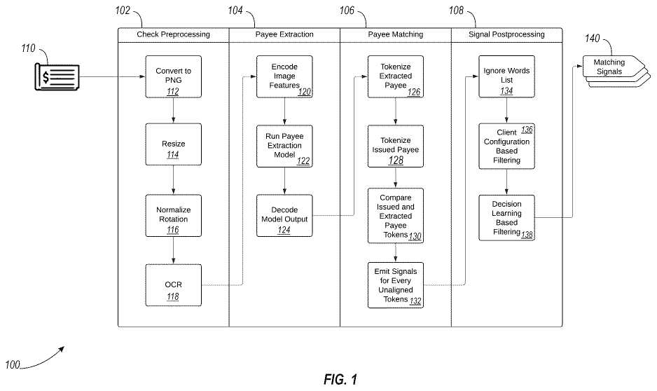

Looking first at FIG. 1, one embodiment of an architecture 100 for a positive pay match system is depicted. Embodiments of this architecture may comprise four stages. A first stage 102 is check preprocessing. Check 110 images may be normalized to ensure that the rest of the system is not sensitive to noise introduced by the digital scanning process. The preprocessing includes, in some embodiments, a conversion 112 to PNG (or other format), a resize 114, and a resolution normalization 116. The last step of stage 102 is to run optical character recognition (OCR) 118 on the preprocessed image. A second stage 104 may be payee extraction. Stage 104 may be adapted to extract from the check a set of (e.g., every bit) of information that is relevant to the positive pay service, like the payee's name and the addressee's name. In some embodiments, stage 104 may include encoding image features 120, running a payee extraction model 122, and decoding the model output 124. Another stage 106 may comprise payee matching. In some embodiments, stage 106 may include tokenizing extracted payees 126 and tokenizing issued payees 128. Next, extracted information (e.g., from a presented check) may be compared 130 with the information that was previously sent by the entity that issued the check (e.g., another image of the check or issued check data such as an issued check ledger). The result of this stage is referred to as “matching signals” 132, a set of fine-grained data points that are easy to understand by a human reviewer and describe the results of the application of the matching algorithm. Another stage may thus comprise a signal postprocessing stage 108. In this stage, a postprocessing pipeline may be applied to remove or filter signals based on a configuration. This configuration may be provided by a user of the positive pay system such as an entity (e.g., business) comparing checks. Users can opt to ignore certain signals, resulting in significantly less false positives (e.g., at the cost of accruing a small amount of fraud risk. One such configuration may be a decision learning algorithm, that remembers past decisions (e.g., of a user associated with approving or denying checks based on signals provided by the positive pay match system or regarding individual payees) and filters signals based on that data. In some embodiments, stage 108 may include an ignore words list 134, client configuration based filtering 136, and decision learning based filtering 138. The final output of stage 108 are the matching signals 140 (discussed below).

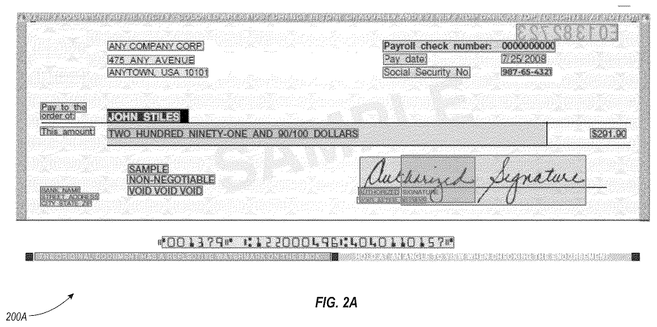

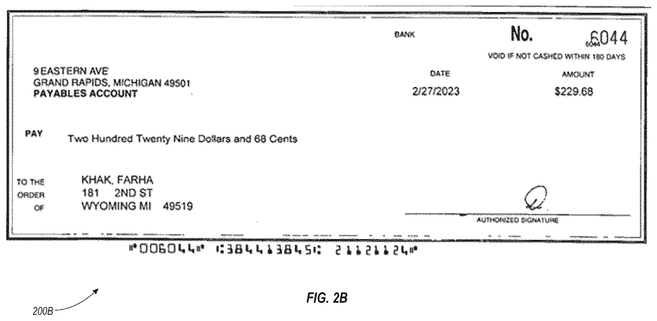

It will now be useful to discuss how these stages may be implemented in various embodiments. In one embodiment, check preprocessing may be performed on checks that are presented for payment at an entity (e.g., at a financial institution). These checks may be presented as images of checks presented for payment at the entity. For example, an employee or other use associated with an entity may create an image of a paper check presented for payment or the check may be scanned when presented for payment at the entity. The check may also be presented for payment using mRDC or the like. In any event, the positive pay system of embodiments may receive a (image of) a check presented for payment. FIGS. 2A and 2B depict examples of such check images 200A, 200B. Additionally, the positive pay system may receive payee data from the entity that issued this check. This payee data may comprise an image of the same check as issued or may comprise (e.g., ledger) data comprising a payee name or names associated with one or more checks issued by that entity, including the check received for payment by the positive pay system.

Every check that is presented for payment goes through a preprocessing stage. This is the stage where the check is prepared to be analyzed. Image normalization and optical character recognition (OCR) are performed. The goal is to correct some of the imperfections in the check scan and accurately identify all the text contained.

In one embodiment, normalization is comprised of: 1) converting all the images to a uniformed format. For example, PNG. 2) Rotating the check image so it is straight or otherwise aligned. 3) Resizing the image to a pre-defined resolution, and 4) Running optical character recognition (OCR) to detect all the text contained within the check. An important factor to consider when dealing with check is to ensure is the ability to recognize or read handwritten text. Thus, in some cases an OCR engine that may effectively recognize handwritten text may be utilized such as AWS Textract.

The check preprocessing stage solves the technical problem that checks are often scanned differently and arrive with varying levels of image noise and low quality. Financial institutions typically have no control over the quality of the image as it is scanned by the receiver's bank. Accordingly, the image normalization steps (including conversion to a uniformed format, rotation, and resizing) are beneficial technical solutions that ensure the rest of the system is not sensitive to noise introduced by the physical scanning process. Furthermore, the system addresses the specific technical challenge of recognizing and extracting data from handwritten text, which prior systems often failed to handle well.

In the next stage, key data such as, or related to, the payee of the check presented for payment may be extracted (e.g., data extracted from the check image or the check image itself) using a model trained on a particular dataset. These fields may include, and be labeled, “payeeName”, “address”, “addresseeName”, and “addresseeCode”. The model may be fine-tuned on the dataset. In one embodiment, the positive pay system may be included in a network having access to a large number (e.g., thousands or more) of checks that are constantly being updated or added to. Thus, many thousands (e.g., 10,000 or so) may be labeled and new samples constantly added to this dataset. Such a dataset may allow active learning techniques to be employed and reach accuracy metrics of upwards of 98%.

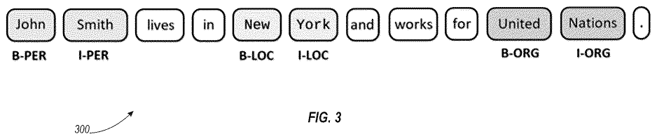

In one embodiment, a Multi-Modal Transformer model (for example LayoutLM) may be utilized to extract key information from check images. This model may be pre-trained according to certain embodiments according to the specific data and datasets utilized by embodiments. Embodiments may add a token classification head on top of the pre-trained model to perform IOB tagging. What that means is that every word in a check is classified as either B (for ‘Beginning’ of an extracted field), I (for ‘Inside’ an extracted field), or O (for ‘Outside’ a field). This scheme enables embodiments to extract multi-token fields unambiguously. FIG. 3 shows how this scheme 300 is usually employed in named entity recognition, similarly to how it may be employed in embodiments. However, according to embodiments, tokens may be spread in a 2-D surface (e.g., the check image).

In the next stage, the payee matching stage, the data that was extracted from a check (e.g., in the payee extraction stage) can be compared to the data associated with the check(s) issued by the check issuer (e.g., the data included in the issued check file/ledger). Anything that is deemed a (e.g., possible) mismatch between the two may be determined (e.g., for reporting to a user). This comparison process is designed to execute both positive validation and negative validation. Positive validation confirms that the issued payee name is present on the check image. Distinct from conventional systems, the system also performs negative validation. This involves identifying and flagging any extra or unexpected payee names or addressee names found on the check that were not present in the issued data. This capability to perform both validation types represents a difference from typical systems that generally only perform positive validation.

In one embodiment, a payee matching algorithm for performing such matching may operate in a number of steps: 1) Tokenization, where the issued and extracted fields are both split into words that can be analyzed independently. For example, “John Doe” is split into “John” and “Doe”. 2) Normalization, where procedures are applied to each token to normalize the tokens (e.g., like NFD Unicode equivalence, removal of diacritics, lowercasing etc.). For example, “François” becomes “francois” for easier comparison, and 3) Matching, where a fuzzy n-gram matching algorithm may be used to carefully align the issued tokens with the extracted tokens. The n-gram portion of the algorithm, where consecutive words are paired together for comparison, tries to mitigate a very common OCR error that fails to capture spaces properly, so “John Doe” can be captured as “JohnDoe” and not affect matching. The fuzziness also tries to correct common OCR errors like the letter “O” being captured as the number “0”. Fuzziness tolerance may be measured, for example, in Levenshtein distance.

The payee matching algorithm also specifically acts as a technical solution to mitigate errors introduced by the OCR system. The fuzzy n-gram matching algorithm corrects common OCR output defects, such as the failure to properly capture spaces (e.g., confusing “John Doe” with “JohnDoe”) or mistaking similar characters (e.g., confusing the letter “O” with the number “0”).

The result for this payee matching algorithm may be a list of unmatched tokens and where they are in the check, with the purpose of flagging potential frauds. These may be referred to as “matching signals”, or just “signals”. At the end of this stage a list of signals is produced. These signals may look like this: “The word ‘John’ was found on line 2 of the addressee name but it wasn't found in the issued payee name”. The signals contain information like:
Which word was not matched. This is the pre-normalization word, so reviewers can easily spot the errors in the check without having to decipher what a normalized token means. Special data structures may be used to keep track of pre and post normalization tokens flowing through the system.
What field does that word come from (e.g., “payee name” or “addressee”.)
What line of that field is that word located. It's common for addressee fields to contain more than one line of information, so we direct the reviewer to which line the signal refers to.

One of the goals of a positive pay system is to clearly inform users reviewing a check exactly why it was flagged for review. This can be challenging to achieve with machine learning systems, especially those that utilize deep learning techniques. That's due to the nature of how these models work, many times being functionally a “black box”.

So, in one embodiment, instead of presenting a models' output directly to the reviewer, the output of the model may be evaluated to produce “matching signals” instead. This is the difference between saying “This check has an 80% chance of being fraudulent” and “The issued payee name ‘Michael’ never appears on the check”. The former offers no explanation for how that probability was determined. This lack of transparency is problematic, especially when similar-looking checks are flagged inconsistently, leaving clients without the context needed to trust the system or justify their decisions.

Certain embodiments of the system can thus emit the following matching signals:
ISSUED_PAYEE_NAME_NOT_MATCHED—Emitted for every word in the issued payee name that is not found in the check. The signal contains information of what word wasn't matched.
EXTRA_PAYEE_NAME—Emitted for every payee name or addressee name word in the check that doesn't match any of the issued payee name words. The signal contains information of what word wasn't matched and where that word is located (e.g. line 2 of the addressee's name).
EXTRACTION_FAILED—Emitted when the system can't find any payee information in the check.
NO_ISSUED_PAYEE—Emitted when a check has no payee name issued.

If the system emits any of the signals above the check is flagged for review. These signals clearly explain why a check was flagged, enabling reviewers to determine the appropriate course of action.

Certain accounts issue checks to specific payees on a periodic basis, like a restaurant issuing a check to a pest control company every month. One observed issue with these checks is the issued payee in the check issue file is slightly different than the payee written on the check. The systems that issue these checks are varied and it is too costly and complex to require all clients to change their printing system to fix this issue.

Accordingly, certain embodiments may employ decision learning. Decision learning is a feature that reduces the number of false positives or negatives that occur with these checks without a user needing to make changes to their systems. The implementation of this decision learning-based filtering directly results in the computer system operating better and more efficiently. Prior art solutions typically have a high flagging rate for human review, e.g., roughly 10-12%. However, the disclosed system, utilizing decision learning, has demonstrated a reduction of this human review flagging rate to approximately 3%. This technical advancement improves on a previously cumbersome manual review process and drastically reduces the computational workload required for continuously reprocessing known, approved check characteristics. For every check that runs through the payee matching system users can make informed decisions to clear or deny checks using the signals that were returned as described above. Embodiments of this decision may be based on the fact that embodiment of the positive pay system uses explainable signals, which allow embodiments to record the signals and apply them on future check runs. These decisions are received from the users and stored in a database along with key identifying information from the check, specifically embodiments may store data such as:
Override Status (OverrideStatus)—either DENY or ALLOW
Internal identifier for the financial institution (FINumber)—e.g. 11111111
Account number for the check (AccountNumber)—e.g. 1234567
Issued payee as listed in the check issue file (IssuedPayee)—e.g. John Doe.
Extracted payee which is the exact text that was extracted from the check as the payee (ExtractedPayee)—e.g. John Mike Doe

Since an account may be issuing a check to a payee on a periodic basis and these checks will have the same key check information this decision can be used for all future checks from that account issued to that specific payee. As part of the post-processing step a database (or other) lookup will occur using FINumber, AccountNumber, IssuedPayee and ExtractedPayee of the currently processing check. If there is a match in the database the OverrideStatus will be used to change the fraud signals that are to be returned. Note that in this implementation the fields may need to match exactly, for example if there was extra text written on the check and therefore the ExtractedPayee had extra characters the database lookup would not find an entry and no decision would be used. There could be other embodiments that allow for cases where the ExtractedPayee will not match exactly. Techniques to use in these cases are normalizing the text by stripping whitespaces and removing special characters from the text, as well as reusing the same n-gram matching algorithm used in the payee matching section described above.

Even though decision learning will remove signals from the response, a processing note will be applied on every response. The processing note applied will be text that allows the reviewer to understand details of what happened to the check in the system. For decision learning, this processing note will allow the reviewer to understand that an override was found in the database and applied to currently processing check. This makes sure the system has explainable results, and the reviewer knows exactly when decision learning is running and changing output signals.

Embodiments of how the override status may change the (e.g., fraud) signals produced by the system may be as follows:

### Override Status: ALLOW

Allow status means that the check was cleared and allowed to be paid when the system originally raised a fraud signal. Causes of this can be differences in the issued payee and extracted payee including but not exclusively: extra middle names, honorifics and corporate suffixes.

| Decision made for original check | Future checks for that account |
|---|---|
| Consider a check with the following | Consider a new check for that account |
| information: | comes in: |
| FIAccountNumber: 111111111 | FIAccountNumber: 111111111 |
| Account number: 1234 | Account number: 1234 |
| Issued payee: John Doe | Issued payee: John Doe |
| Extracted payee: John Mike Doe | Extracted payee: John Mike Doe |
| Original response | Signal (none) |
| Signal: Word “Mike” was found on line 1 | Exception: (none) |
| of the payee, but was not issued. | processing note: Override applied, an |
| Exception: PAYEE NAME MISMATCH | override was found and applied for this |
| processing note: (none) | check |
| Reviewer provided feedback | |
| Decision: ALLOW | |

### Override Status: DENY

Deny means that the reviewer believes that the check should not be paid and should have been flagged by the system.

| Decision made for original check | Future checks for that account |
|---|---|
| Consider a check with the following | Consider a new check for that account |
| information: | comes in: |
| FIAccountNumber: 111111111 | FIAccountNumber: 111111111 |
| Account number: 1234 | Account number: 1234 |
| Issued payee: John Doe | Issued payee: John Doe |
| Extracted payee: John Doe Alice | Extracted payee: John Doe Alice |
| Cooper | Cooper |
| Original response | Signal: OVERRIDE applied. |
| Exception: (none) | DENY_PAYMENT |
| Signal: (none) | Exception: DENY_PAYMENT |
| processing note: (none) | processing note: Override applied, an |
| Reviewer provided feedback | override was found and applied for this |
| Decision: DENY | check |

As discussed, embodiments may payee of the check presented for payment may be extracted (e.g., data extracted from the check image or the check image itself) using a model trained on a particular dataset. The training, testing and benchmarking sets of images for the (e.g., multimodal transformer) model must be varied and distinct to better represent different formats of checks from various entities (e.g., financial institutions such as banks). Since in the production set of real-world data, there exist possibly hundreds of thousands of usable checks, a filter (e.g., a filtering algorithm) may be employed by embodiments to determine useful and varied samples to be included in the dataset(s) used for training a model. The use of such carefully constructed datasets may cause the model generated using such dataset to generalize better on anomalous and challenging samples while improving its false positive and negative rates.

Embodiments may be usefully described with reference to the images depicted in FIGS. 2A and 2B in mind. According to embodiment therefore, in a production bucket, images are stored in folders segregated first by account numbers (e.g., associated with financial institutions) and further by dates. Before clustering, when picking out samples for evaluation, first the number of accounts (e.g., through check ID) are noted and for only certain chosen dates, the samples are counted. A per-account sample ratio is arrived at by considering the total number of samples. This same ratio may be maintained while feeding all check images to the feature extractor model. It ensures the retention of the ratio split between different account numbers found in production.

To cluster checks, firstly, an image extractor must learn and distinguish between their image features. Lower-level features such as edges, text, lines and higher-level features like watermarks, logos, symbols and spatial context respectively need to be learned by the model in question (e.g., the VGG-16 convolutional neural network).

Cheque formats may be determined by their respective lower and higher-level visual features that a convolutional network extracts as mathematical matrices. For example, in the check 200A shown in FIG. 2B, lower features learned in the earlier layers could be points, edges, textures, text characters etc. Whereas symbols, watermarks, spatial context and more are learned by the later layers of the (e.g., VGG-16) feature extractor.

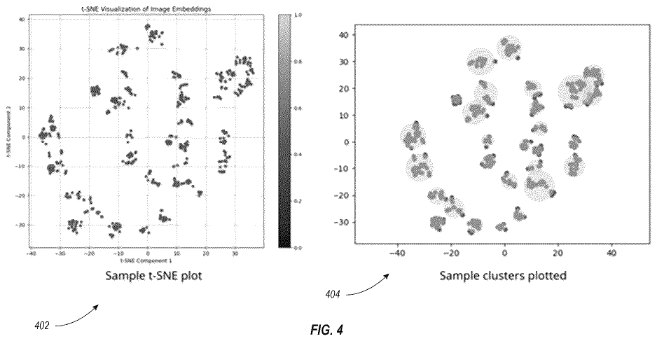

The clusters formed in a two-dimensional plane are depicted in FIG. 4 for the sake of visual understanding of how the process unfolds and what it results in. A t-SNE plot 402 compresses all features into two dimensions/components and a rough set of clusters 404 are formed over this feature set. The same process is repeated multiple times over fifty-hundred dimensions instead of merely two. The more reduction that's applied, the more valuable information that is lost. Thus, a balance must be struck between how rich the features are and to what extent the clustering algorithm can perform so results can be meaningful.

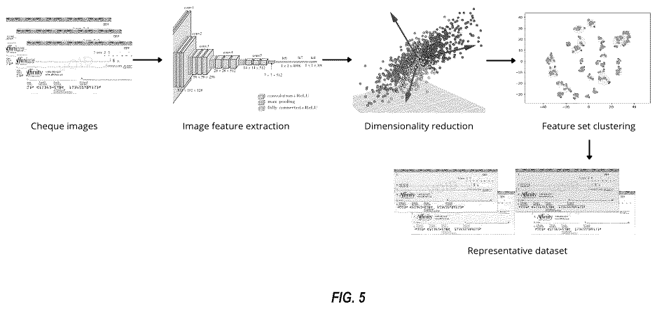

A block diagram representing an embodiment of a method for image clustering is depicted in FIG. 5. In one embodiment therefore, a feature extractor (e.g., a VGG-16 convolutional neural network) is trained on an existing dataset of checks to familiarize it with check-specific patterns. New check images from a production set (e.g., a set of check images) are fed to the model and eight alternating layers of the model are used for feature extraction. Thus, both lower and higher-level features are prioritized well and computational power used is minimized (e.g., as compared to using the entire model).

These (e.g., resulting) matrices are multidimensional and may be compressed (e.g., effectively) such that clustering may occur. Hence, the Principal component analysis may be used for this purpose. Principal component analysis (PCA) is a statistical method that reduces the dimensionality of a data set while retaining the most important variations.

Further, a (e.g., K-Means) clustering algorithm is iteratively run over thousands of samples a few hundred times. Depending on the silhouette score and slope of the elbow curve plotted, the ideal number of clusters is chosen. Each cluster contains visually similar checks with varying levels of closeness to the cluster center. The closer a sample is, the more alike it is. This also gives rise to intra-cluster variety when picking images for the datasets. Once the clusters are grouped, a fixed ratio is used to extract samples from each cluster which splits itself. The final list of check identifiers is used to retrieve and populate a training, testing and benchmarking set for training the model.

The training set is chosen by balancing out samples from different accounts (e.g., accounts associated with the checks of the production set) to produce an evenly distributed set with format diversity whereas during test/evaluation, the real-world account number sample ratios are maintained for reduced bias and accurate performance estimation. This is how the algorithm picks relevant and varied sample sets for training, testing and benchmarking. It plays a significant role in precisely evaluating model performance since it matches production data distribution and contains a diverse set of image samples.

Hence, in one embodiment, the main goals of performing clustering are: to include rarer check templates and reduce redundancy/duplication of commonly occurring formats; to maintain the real-world data distribution split based on cheque account numbers found in the production set while extracting features and clustering; and to reduce the bias in the datasets and create a test set that objectively emulates the actual account number split.

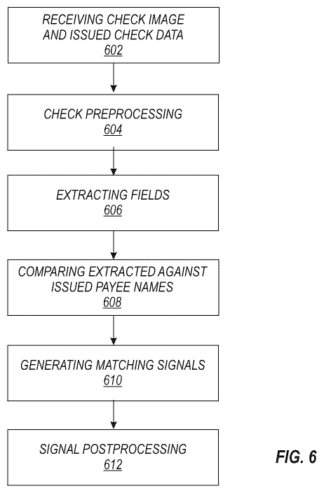

FIG. 6 is a flow chart illustrating one embodiment of a method for detecting anomalies in checks using a positive pay match system. In this example, at step 602, a check image and associated issued check data are received, where the issued check data includes an issued payee name. This issued check data may comprise ledger data or an image of the check as originally issued. At step 604, check preprocessing is performed, which may include image normalization and OCR. One goal of preprocessing is to prepare the check for analysis by correcting imperfections in the scan and accurately identifying all contained text. The OCR used is configured to recognize handwritten text. At step 606, a set of fields is extracted from the OCR output using a trained multi-modal transformer model. This model extracts key data related to the payee, including the extracted payee name. The multi-modal transformer model may be, for example, LayoutLM. At step 608, the extracted payee name is compared against the issued payee name using a payee matching algorithm. In one embodiment, this algorithm involves several sub-steps, such as:
Tokenizing the issued and extracted payee names into independent tokens.
Normalizing these tokens by applying procedures such as NFD Unicode equivalence, removal of diacritics, or lowercasing.
Aligning the normalized tokens using a matching algorithm, which may include a fuzzy n-gram matching algorithm to mitigate OCR errors.

At step 610, a list of matching signals is generated based on any tokens that remain unaligned. Each matching signal is a discrete unit of information describing a specific finding or mismatch between the issued data and the extracted data. These signals are designed to be explainable, clearly informing reviewers exactly why a check was flagged. Finally, at step 612, signal postprocessing is performed. This postprocessing includes decision learning-based filtering, which utilizes human review feedback stored in a database to determine if a check associated with the check image should be flagged for human review. This decision learning algorithm can filter signals based on past user decisions to reduce false positives. If the decision learning status is “ALLOW,” fraud signals may be removed from the response and a processing note applied.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. A “computer-readable medium” may be any type of data storage medium that can store computer instructions that are translatable by a processor. Examples of computer-readable media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like. Data may be stored in a single storage medium or distributed through multiple storage mediums, and may reside in a single database or multiple databases (or other data storage).

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any particular routine can be executed on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit CPU or other processor, memory (e.g., primary or secondary memory such as RAM, ROM, HD or other computer readable medium for the persistent or temporary storage of instructions and data) and an input/output (“I/O”) device. The I/O device can include a keyboard, monitor, printer, electronic pointing device (for example, mouse, trackball, stylus, etc.), touch screen or the like. In embodiments, the computer has access to at least one database on the same hardware or over the network.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within a claim otherwise. Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the figures can also be implemented in a more separated or integrated manner, or even removed or rendered as inoperable in certain cases, as is useful in accordance with a particular application. Additionally, any signal arrows in the figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

In the foregoing specification, the invention has been described with reference to specific embodiments. However, one of ordinary skill in the art appreciates that various modifications and changes can be made without departing from the scope of the invention. Accordingly, the specification, including the Summary, Abstract and figures are to be regarded in an illustrative rather than a restrictive sense, and all such modifications are intended to be included within the scope of invention.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine-readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

What is claimed is:

1. A method for detecting anomalies in checks using a positive pay match system, the method comprising:
receiving a check image and associated issued check data, the issued check data including an issued payee name;
performing check preprocessing, including image normalization and optical character recognition (OCR), the OCR configured to recognize handwritten text and produce OCR output;
extracting, by a trained multi-modal transformer model, a set of fields from the OCR output, the set of fields including an extracted payee name;
comparing the extracted payee name against the issued payee name using a payee matching algorithm, the algorithm including:
tokenizing the issued and extracted payee names into independent issued payee name tokens and extracted payee name tokens;
normalizing the issued payee name tokens and extracted payee name tokens; and
aligning the normalized issued payee name tokens and extracted payee name tokens using a matching algorithm;
generating a list of matching signals based on unaligned tokens, wherein each matching signal is a discrete unit of information describing a specific finding or mismatch; and
performing signal postprocessing, the postprocessing including decision learning-based filtering configured to utilize human review feedback stored in a database to determine if a check associated with the check image should be flagged for human review.

2. The method of claim 1, wherein the trained multi-modal transformer model is utilized to perform token classification using an IOB tagging scheme.

3. The method of claim 1, wherein the normalizing further comprises applying procedures to the tokens including at least one of NFD Unicode equivalence, removal of diacritics, or lowercasing.

4. The method of claim 1, wherein the matching algorithm utilizes a fuzzy n-gram matching algorithm to perform the aligning of the normalized issued payee name tokens and extracted payee name tokens, wherein the fuzzy n-gram matching algorithm mitigates OCR errors that fail to capture spaces properly.

5. The method of claim 1, wherein the aligning of the normalized issued payee name tokens and extracted payee name tokens using the matching algorithm is performed using a fuzzy n-gram matching algorithm, and wherein the fuzziness tolerance is measured by Levenshtein distance.

6. The method of claim 1, wherein utilizing human review feedback stored in the database comprises matching the stored feedback based on the combination of a financial institution identifier, an account number, the issued payee name, and the extracted payee name of a respective check.

7. The method of claim 1, wherein generating a list of matching signals includes generating at least one signal selected from the group comprising:
a signal indicating extracted information present on the check but absent from the issued check data; and
a signal indicating issued information absent from the extracted payee name.

8. A computer security system for machine learning based fraud detection in checks for positive pay applications, the system comprising:
one or more processors coupled to a non-transitory computer readable medium storing instructions, the instructions executable by the one or more processors to implement:
a check preprocessing module configured to receive a check image and perform image normalization and optical character recognition (OCR), wherein the OCR is configured to recognize handwritten text and produce OCR output;
a payee extraction module comprising a trained multi-modal transformer model, the payee extraction module configured to extract a set of fields from the output of the OCR output, the set of fields including an extracted payee name;
a payee matching module configured to compare the extracted payee name against an issued payee name included in associated issued check data, the comparison including:
tokenizing the issued and extracted payee names into independent issued payee name tokens and extracted payee name tokens;
normalizing the issued payee name tokens and extracted payee name tokens; and
aligning the normalized issued payee name tokens and extracted payee name tokens using a matching algorithm;
the payee matching module further configured to generate a list of matching signals based on unaligned tokens, wherein each matching signal is a discrete unit of information describing a specific finding or mismatch;
a signal postprocessing module configured to apply decision learning-based filtering to the matching signals, the decision learning-based filtering configured to utilize human review feedback stored in a database to determine if a check associated with the check image should be flagged for human review.

9. The computer security system of claim 8, further comprising a decision learning database configured to store records for previously reviewed checks.

10. The computer security system of claim 8, wherein the payee extraction module comprises a multi-modal transformer model that is LayoutLM pre-trained and fine-tuned on manually labeled checks.

11. The computer security system of claim 8, wherein the matching algorithm utilized by the payee matching module for aligning the normalized issued payee name tokens and extracted payee name tokens is a fuzzy n-gram matching algorithm.

12. The computer security system of claim 8, wherein the check preprocessing module is configured to normalize the check image by performing at least one operation selected from the group consisting of: converting the image to a uniformed format, rotating the image, or resizing the image to a pre-defined resolution.

13. The computer security system of claim 9, wherein the records stored in the decision learning database comprise, for a given check, a combination of an override status, a financial institution identifier, an account number, an issued payee name, and an extracted payee name.

14. The computer security system of claim 13, wherein if the stored override status is allow and a currently processing check matches the combination of stored identifiers, the signal postprocessing module is configured to remove fraud signals from the response and apply a processing note indicating that an override was applied.

15. A computer program product comprising a non-transitory computer readable medium storing instructions translatable by a processor, the instructions when translated by the processor perform:
receiving a check image and associated issued check data, the issued check data including an issued payee name;
performing check preprocessing, including image normalization and optical character recognition (OCR), the OCR configured to recognize handwritten text and produce OCR output;
extracting, by a trained multi-modal transformer model, a set of fields from the OCR output, the set of fields including an extracted payee name;
comparing the extracted payee name against the issued payee name using a payee matching algorithm, the algorithm including:
tokenizing the issued and extracted payee names into independent issued payee name tokens and extracted payee name tokens;
normalizing the issued payee name tokens and extracted payee name tokens; and
aligning the normalized issued payee name tokens and extracted payee name tokens using a matching algorithm;
generating a list of matching signals based on unaligned tokens, wherein each matching signal is a discrete unit of information describing a specific finding or mismatch; and
performing signal postprocessing, the postprocessing including decision learning-based filtering configured to utilize human review feedback stored in a database to determine if a check associated with the check image should be flagged for human review.

16. The computer program product of claim 15, wherein the trained multi-modal transformer model is utilized to perform token classification using an IOB tagging scheme.

17. The computer program product of claim 15, wherein the normalizing further comprises applying procedures to the tokens including at least one of NFD Unicode equivalence, removal of diacritics, or lowercasing.

18. The computer program product of claim 15, wherein the matching algorithm utilizes a fuzzy n-gram matching algorithm to perform the aligning of the normalized issued payee name tokens and extracted payee name tokens, wherein the fuzzy n-gram matching algorithm mitigates OCR errors that fail to capture spaces properly.

19. The computer program product of claim 15, wherein utilizing human review feedback stored in the database comprises matching the stored feedback based on the combination of a financial institution identifier, an account number, the issued payee name, and the extracted payee name of a respective check.

20. The computer program product of claim 15, wherein generating a list of matching signals includes generating at least one signal selected from the group comprising:
a signal indicating extracted information present on the check but absent from the issued check data; and
a signal indicating issued information absent from the extracted payee name.

21. The method of claim 1, wherein the trained multi-modal transformer model is trained on a training dataset curated via an image clustering process, the image clustering process comprising:
extracting image features from a plurality of historical check images using a convolutional neural network;
reducing a dimensionality of the extracted image features;
grouping the historical check images into clusters based on the reduced image features using a clustering algorithm; and
selecting a subset of the historical check images from the clusters to form the training dataset to maintain a production distribution of check formats.
